(19) United States
(12) Patent Application Publication
(10) Pub. No.: US 2004/0120262 A1
(43) Pub. Date: Jun. 24, 2004

(54) Site monitor and method for monitoring site

(76) Inventors: Shinji Hirose, Tokyo (JP); Makoto Tsuchiya, Tokyo (JP)

Correspondence Address: GRIFFIN & SZIPL, PC, SUITE PH-1, 2300 NINTH STREET, SOUTH, ARLINGTON, VA, 22204, US

(21) Appl. No.: 10/333,758

(22) PCT Filed: Jul. 24, 2001
(86) PCT No.: PCT/JP01/06370

(30) Foreign Application Priority Data
Jul. 25, 2000 (JP) 2000-224530
Jul. 25, 2000 (JP) 2000-224531

(51) Int. Cl. H04L 1/00

(52) U.S. Cl. 370/252; 370/395.52

(57) ABSTRACT

A remote monitor disposed adjacently to a site having at least one server and monitoring the operating state of the site and the server comprises a first communication processing section connected with a global IP region and communicating with a monitor center through the global IP region at a first encrypted security level, and a second communication processing section connected with a local IP region and communicating with a server through the local IP region at a security level lower than the first security level Specified data is generated according to a monitoring item of the operating state of the server and transmitted, and the data on the monitoring of the operating state of the site is received. Data on the operating state is generated therefrom and sent to the monitor center through the first communication processing section.

INDUSTRIAL FIELD OF TECHNOLOGY

This invention relates to a monitoring system which monitors, through the use of a network, a server which belongs to a site connected to the Internet.

### BACKGROUND OF THE INVENTION

Due to popularization of the Internet, a good many of sites have been operated. These sites have in general a plurality of servers, and a data communication is carried out bilaterally between the servers by a dedicated network such as LAN, and on the other hand, it is configured such that each server can communicate with outside through a global IP region such as the Internet.

For example, between the servers, on the occasion that a WWW server requests for a search to a DB server and so on, a communication is carried out through the use of the dedicated network.

In the past, in these sites, a monitoring apparatus is placed on the dedicated network, and a server which is placed within the site transmits and receives data by streaming signals on the dedicated network so that the server within the site has been monitored.

However, in the conventional monitoring apparatus, in case that an operator is assigned to the monitoring apparatus, and the result of the monitoring is studied, and an abnormal condition etc. has been occurred, there was a necessity for the operator to act for taking an appropriate action. Therefore, there is a necessity to assign an operator who has knowledge of a network etc. to the monitoring apparatus.

Also, in case that the operator can not resident at the monitoring apparatus, even when the abnormal condition occurs and an alarm is activated, there is a possibility that the operator can not recognize this.

Also, in the above-described monitoring apparatus, data is applied to a server through the use of the dedicated network, and data which responded is received from the server. Accordingly, there was also such a problem that it is possible to monitor from the side of the dedicated network but it is impossible to monitor from the side of the global network through which accesses from outside are carried out. Further, there was also such a problem that, in case that data communication within an internal dedicated network is stopped, it is difficult to notify to an external terminal.

An object of the invention is to provide a monitoring apparatus which can appropriately monitor a condition of a server within a site, without assigning an operator to the site.

Also, an object of the invention is to provide a monitoring system which can monitor the operating condition or the like of a server, by giving data to the server from both of a dedicated network region which can be utilized for communication with a site (local IP region) and a global IP region which can be utilized for communication with outside.

Another object of the invention is to provide a monitoring system which can notify an operation condition of a site to an operator of the site and control the site, without giving a load to the site operator.

Also, anther object of the invention is to provide a monitoring system which can monitor a plurality of sites and servers in a unified manner, by disposing a monitoring center.

### DISCLOSURE OF THE INVENTION

The object of the invention is accomplished by a site monitoring apparatus which is disposed adjacently to a site having at least one server or more and monitors operating conditions of the site and/or the server, comprising first communication processing means connected to a global IP region for communicating encrypted data with a central monitoring center through the global IP region at a first security level, second communication processing means connected to a local IP region for communicating data with the above-described server through the above-described local IP region at a second security level lower than the first security level, a monitoring execution means for generating predetermined data according to monitoring items for monitoring the operating conditions of the above-described site and/or server, and monitoring data generation means for receiving monitoring data which was returned from the above-described second communication processing means in response to data which was sent and relates to operating conditions of the above-described site and/or server and for generating data which shows the operating conditions according to the monitoring data, wherein, the data which was generated by the above-described monitoring data generation means is notified to the above-described central monitoring center, through the above-described first processing means.

According to the invention, operating conditions of the server etc. are monitored in the local IP region, and the monitoring data which shows the monitoring conditions is transmitted to the central monitoring center through the global IP region at the higher first security level. Accordingly, as to the operating conditions of the site, it is possible to monitor as desired, and on the other hand, its result can be supplied to the central monitoring center, maintaining secrecy. By this, it becomes possible to monitor a large number of sites in a unified manner by the central monitoring center.

In a preferred embodiment of the invention, the above-described second communication processing means is configured such that, in order to monitor, through the above-described global IP region, the operating conditions of the site and/or server connected to this, data which was given from the above-described monitoring execution means is sent out, and data which was returned through the above-described global IP region in response to the sending out of the data is received.

By such a structure, it becomes possible to realize a monitor etc. of response time of the server and HTTP services by the monitoring which passed through the global IP region.

In a further preferred embodiment of the invention, the above-described monitoring execution means judges that there is something abnormal in the above-described site and/or server, based upon the above-described monitoring data, data which shows an alarm is generated, and data which is the data showing the alarm and was encrypted is transmitted from the first communication processing means to the central monitoring center at the first security level.

Also, in another embodiment of the invention, in cooperation with the above-described site monitoring apparatus, a central system of a central monitoring center for monitoring more than one site is configured that a control command which shows a manner of monitoring of the above-described site and/or server is applied to the above-described site monitoring apparatus at the first security level, and data from the above-described site monitoring apparatus is received, and according to the data, operating conditions of the site and/or server is grasped. By disposing such a central system,it becomes possible to have the site monitoring apparatus unmanned.

Also, in a further preferred embodiment, the central system is configured such that, through the global IP region, a control command of other computer is received, and the control command is transmitted to a predetermined site monitoring apparatus.

For example, other computer corresponds to a client computerforanoperatorofthesiteandtheserver. Accordingly, it becomes possible to also notify results of monitoring appropriately to the operator.

In a further preferred embodiment, the central system is configured such that data from the above-described site monitoring apparatus is received, and a report based upon the data is prepared and transmitted to predetermined other computer.

In still another embodiment of the invention, the central system comprises a knowledge base and a supporting apparatus which indicates desired works to an operator in reference to the knowledge base. By this, it becomes possible for even an untrained operator to appropriately grasp conditions and carry out necessary works.

Also, the object of the invention is accomplished also by a method for monitoring a site having at least one server or more characterized by comprising a step of sending data for monitoring the site and/or the server to the above-described server through a local IP region, a step of receiving monitoring data, in response to the above-described site and/or server, which shows the operating conditions of them, and a step of encrypting the above-described monitoring data and sending through a global IP region at a first security level.

Another object of the invention is accomplished by, in a site having at least one or more site, a site monitoring method for monitoring operating conditions of the site and/or the server, characterized by comprising a step of transmitting a command to the above-described site and/or the server through a global IP region and of receiving a response of the command, a step of analyzing operating conditions of the above-described site and/or the server according to the above-described received response, a step of identifying a terminal device which was registered in advance in relation to the site and/or the server, in case that it was judged that there occurred something wrong in the above-described site and/or the server based upon the analysis, a step of preparing a message for notifying the above-described something wrong, and a step of transmitting the prepared message to the above-described terminal device through the global IP region.

According to the invention, without necessity for disposing the monitoring apparatus within the site or the server, and also, without requesting an operator for complicated setting operations etc., it is possible to notify a portable terminal etc. of the operator abnormality of the site and the server. As a result, it is possible for the operator to notice the abnormality of the site or the server which he/she operates wherever he/she is. Also, it becomes possible to monitor a plurality of sites in a unified manner. Further, according to the invention, even when there occur abnormality and trouble in a communication path etc. in the site, if this can be detected by a command from the global IP region and a response to this, it becomes possible to notify the abnormality and trouble to the operator.

In the above-described preferred embodiment of the invention, it is configured such that, further, according to information showing the above-described site and/or the server which were registered in advance and monitoring timing and monitoring content which were registered in relation to the information, the command is transmitted to the above-described site and/or the server through the global IP region.

By this, a desired monitoring content is set to each of the plural sites and the servers, and it becomes possible to carry out a transmission etc. of a command based upon the set monitoring content.

Also, another object of the invention is accomplished also by, in a site having at least one server or more, a site monitoring method for monitoring operating conditions of the site and/or the server, characterized by comprising a step of transmitting an agent program for monitoring at least operating conditions of inside of the above-described server and conditions of a local IP region connected to the above-described server to any server in the above-described site through a global IP region and of urging the above-described server to store the agent program, a step of transmitting an activation command which shows an activation of the above-described agent program to the above-described server through the global IP region, a step of receiving data which was obtained by the above-described server due to operation of the above-described agent program, a step of analyzing operating conditions of the above-described site and/or the server according to the above-described received data, a step of identifying a terminal device which was registered in advance in relation to the site and/or the server, in case that it was judged that there occurs something wrong in the above-described site and/or the server according to the above-described analysis, a step of preparing a message for notifying the above-described something wrong, and a step of transmitting the prepared message to the above-described terminal device through the global IP region.

Further, another object of the invention is accomplished also by, in a site having at least one server or more, a site monitoring method for monitoring operating conditions of the site and/or the server, characterized by comprising a step of transmitting an agent program for monitoring, at a predetermined timing, at least operating conditions of inside of the above-described server and conditions of a local IP region connected to the above-described server to any server in the above-described site through a global IP region and of urging the above-described server to store the agent program, a step of receiving data which was obtained by the above-described server due to operation of the above-described agent program at the predetermined timing, a step of analyzing operating conditions of the above-described site and/or the server according to the above-described received data, a step of identifying a terminal device which was registered in advance in relation to the site and/or the server, in case that it was judged that there occurs something wrong in the above-described site and/or the server according to the above-described analysis, a step of preparing a message for notifying the above-described something wrong, and a step of transmitting the prepared message to the above-described terminal device through the global IP region.

According to these inventions, it becomes possible to realize more detailed monitoring, such as operating conditions of a CPU and management conditions of a file in a server by the agent program, in addition to this, conditions of the local IP region connected to the server etc.

In a preferred embodiment, further, according to the monitoring content, a plurality of agent programs are prepared, and according to the information which shows the above-described site and/or the server which were registered in advance and the monitoring content which was registered in relation to the information, the agent program to be transmitted to the above-described server is selected.

In the above-described invention, it is desirable that the message is transmitted as a mail to a portable terminal. By this, it becomes possible to notify the fact act that there occurred abnormality etc. to an operator of the site and the server, without generating time lag.

Also, another object of the invention is accomplished also by, in a site having at least one server or more, a central system of the central monitoring center connected to the above-described site through a global IP region for monitoring operating conditions of the site and/or the server, comprising communication processing means for transmitting a command to the above-described site and/or the server through the global IP region and receiving a response of the command, operating condition analysis means for analyzing operating conditions of the above-described site and/or the server according to the above-described received response, customer identification means for identifying a terminal device which was registered in advance in relation to the site and/or the server, in case that there occurs something wrong in the above-described site and/or the server based upon the analysis, and message preparation means for preparing a message for notifying the above-described something wrong, wherein it is configured that the prepared message is transmitted to the above-described terminal device through the global IP region.

Also, another object of the invention is accomplished also by, in a site having at least one or more server, a central system connected to the above-described site through a global IP region for monitoring operating conditions of the site and/or the server comprising agent program transfer means for transmitting to any server in the above-described site an agent program for monitoring operating conditions of at least inside of the above-described server and conditions of a local IP region connected to the above-described server, communication processing means for receiving data which was obtained in the above-described server by an operation of the above-described agent program, operating condition analysis means for analyzing operating conditions of the above-described site and/or the server according to the above-described received data, customer identification means for identifying a terminal device which was registered in advance in relation to the site and/or the server, in case that it was judged that there occurred something wrong in the above-described site and/or the server based upon the analysis, and message preparation means for preparing a message for notifying the above-described something wrong, wherein it is configured that the prepared message is transmitted to the above-described terminal device through the global IP region.

In the above-described invention, it is desirable that the above-described communication processing means transfers to the above-described server an activation command which shows an activation of the agent program through the global IP region, and the above-described agent program is operated in response to the activation command. By this, it becomes possible to reduce a load at the side of the server.

### BRIEF DESCRIPTION OF THE DRAWINGS

FIG. 1 is a block diagram which shows a structure of a monitoring system according to a first embodiment of the invention.

FIG. 2 is a block diagram which shows a structure of a remote monitoring apparatus according to the embodiment.

FIG. 3 is a flow chart which schematically shows processing of reporting of site monitoring/alarm according to the embodiment .

FIG. 4 is a flow chart which schematically shows processing of reporting of site monitoring/alarm according to the embodiment.

FIG. 5 is a flow chart which shows data display processing according to the embodiment.

FIG. 6 is a flow chart which shows control processing by a monitoring center according to the embodiment.

FIG. 7 is a block diagram which shows a structure of a monitoring system according to a second embodiment.

FIGS. 8A and 8B are flow charts which show an outline of processing which is carried out in a system according to the second embodiment.

FIG. 9 is a block diagram which shows a structure of a monitoring center according to a third embodiment.

FIG. 10 is a flow low chart which shows an outline of processing which is carried out by the monitoring center of the third embodiment.

FIG. 11 is a flow chart which schematically shows processing of reporting of the site monitoring/alarm according to the first embodiment.

FIG. 12 is a block diagram which shows a structure of a monitoring system according to a fourth embodiment of the invention

FIG. 13 is a block diagram which shows a structure of a central system according to the fourth embodiment.

FIG. 14 is a flow chart which schematically shows processing of requesting a remote monitoring and its registration by an operator of a site according to the fourth embodiment.

FIG. 15 is a flow chart which shows monitoring processing of the site and the server according to the fourth embodiment.

FIG. 16 is a flow chart which shows monitoring processing of the site and the server according to the fourth embodiment.

FIG. 17 is a flow chart which shows transmission of a control command from a portable terminal of an operator to a monitoring center and processing accompanying to this, in the fourth embodiment.

FIG. 18 is a block diagram which shows a structure of a monitoring system according to a fifth embodiment.

FIG. 19 is a flow chart which schematically shows procedures of downloading an agent program in the fifth embodiment.

FIG. 20 is a flow chart which shows processing which is carried out by the server in the fifth embodiment.

### DESIRABLE MODE FOR CARRYING OUT THE INVENTION

### First Embodiment

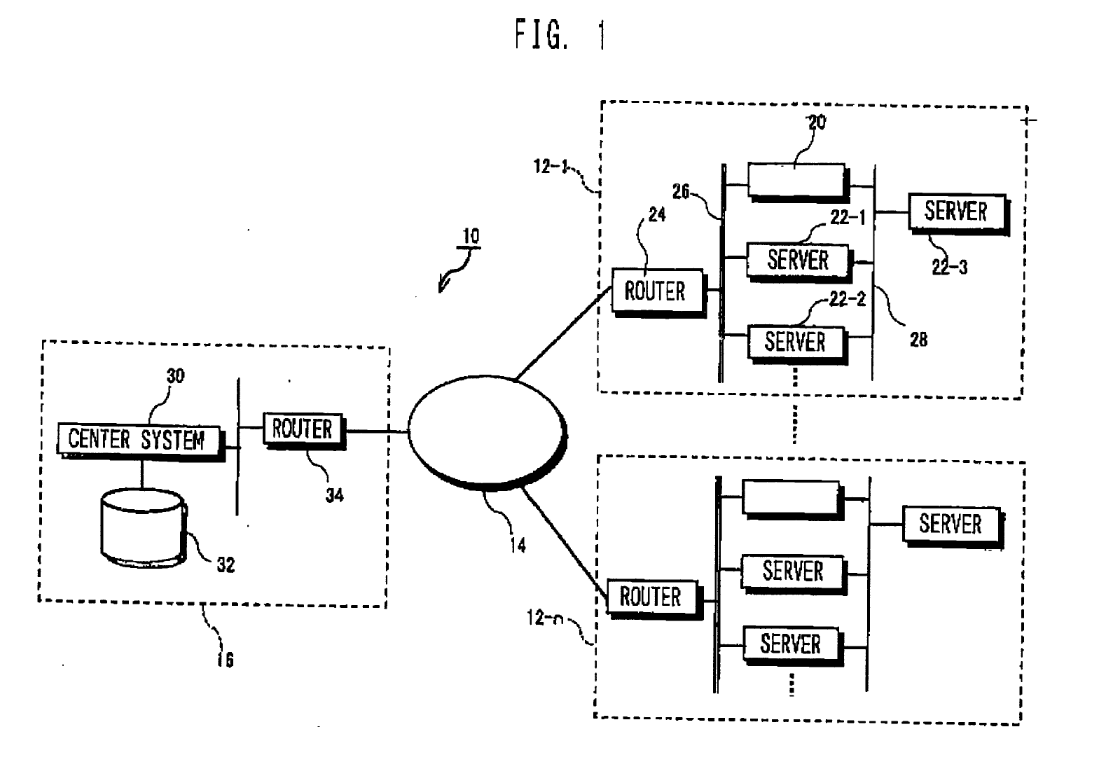

Hereinafter, in reference to accompanying drawings, explanations are added as to embodiments of the invention. FIG. 1 is a block diagram which shows a structure of a monitoring system according to a first embodiment of the invention.

As shown in FIG. 1, in a monitoring system 10, various sites 12-1, ..., 12-n are connected to the Internet 14. Accordingly, the above-described site 12 is designed so as to be able to provide various services and information to personal computers etc. (not shown) through the Internet 14. Also, to the Internet 14, a monitoring center 16, which is for monitoring the above-described site 12 connected through the Internet 14, is connected.

As can be understood from FIG. 1, in this embodiment, one server or more is connected to one site. It is not applied only to one server corresponding to one content provider, and for example, there is a case that a plurality of content providers exist in one server, and on the other hand, there is also a case that one content provider utilizes a plurality of servers. In this specification, the site means a region which is separated by a fire wall from the global IP region, and which has servers connected each other through the local IP region.

Each site 12 is provided with a remote monitoring apparatus 20 which was disposed at a remote position from a monitoring center 16 (i.e., a position adjacent to a server in the site 12), servers 22-1, 22-2, 22-3, ... which belong to the site 12, and a router 24 which finds a server 22 to be connected in reference to a global IP address which was given through the Internet 14 and sends out data from the server 22 to the Internet 14.

The remote monitoring apparatus 20 and the server 22 are respectively connected to a global IP address region 26 as the IP address region which passed through the router 24 at one side and a local IP address region 28 such as LAN for exclusive use in communication between servers at the other side

In the global IP address region 26, data is transmitted through the router 24 to outside (i.e., the Internet 14), or data is entered from the outside. Accordingly, in order to heighten secrecy of data, for example, there is a necessity of encrypting the data for transmission. On the other hand, in the local IP address region 28, since communication is one between only limited servers, secrecy is high by nature.

Accordingly, in the embodiment, the remote monitoring apparatus 20 monitors operating conditions etc. of each server 22, by communication through the local IP address region 28. On the other hand, in case that there is a necessity of transmitting a report of the operating conditions etc and a report in response to abnormality detection to the monitoring center 16, data containing these reports is encrypted and transmitted through the global IP address region 26.

Also, as shown in FIG. 1, the monitoring center 16 has a central system 30 and a data base (DB) 32, and it is designed such that data from the Internet 14 is received through a router 34, or data is transmitted to the Internet 14. The central system 30 can decrypt the encrypted data, and can carry out processing for recognizing its content, and processing for storing data such as operating conditions etc. of each site and each server in the site in DB 32.

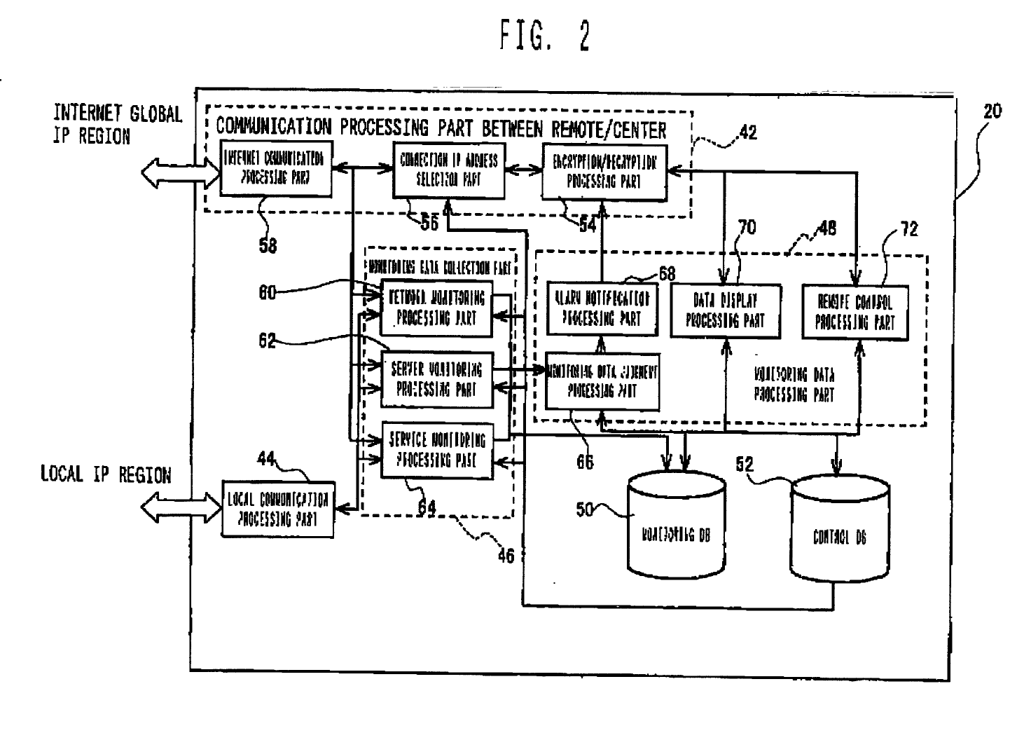

FIG. 2 is a block diagram which shows a structure of the remote monitoring apparatus 20 according to the embodiment. As shown in FIG. 2, it has a communication processing part 42 between remote/center which carries out communication processing between the remote monitoring apparatus and the monitoring center (between remote/center), a local communication processing part 44 which carries out communication processing with the server in the site, a monitoring data collection part 46 which carries out processing for monitoring the servers and processing for transmitting this to each communication processing parts 42, 44, a monitoring data processing part 48 which carries out processing based upon data which was obtained from each server and shows operating conditions and abnormality of each server (monitoring data), a monitoring data base (DB) 50 which stores the monitoring data, and a control DB 52 which stored processing programs and encryption/decryption programs of the remote monitoring apparatus 20 and setting data for carrying out various controls (information showing IP addresses for communication and contents to be monitored).

In more detail, the communication processing part 42 between remote/center has an encryption/decryption processing part 54 which encrypts data to be transmitted to the monitoring center 16 and decrypts data from the monitoring center 16, a connection IP address selection part 56 which brings out an IP address of a place to be connected to from the control DB 52, and an Internet communication processing part 58 which sends out data to the Internet or receives data from the Internet. By the encryption/decryption processing part 54 and the connection IP address selection part 56, VPN (Virtual Private Network) is realized and by this, a secured communication is made possible.

The monitoring data collection part 46 has a network monitoring processing part 60 which monitors a network environment of the local IP region and collects necessary data, a server monitoring processing part 62 which monitors each server 22 in the site 12 and collects necessary data, and a service monitoring processing part 64 which monitors conditions of services which are provided in each server and collects necessary data.

In the embodiment, by the above-described processing parts 60-64, it is possible to monitor the following conditions.

(1) By monitoring a network of the local IP region, abnormality on the network is detected. In more detail, monitoring whether LAN devices, routers, hubs etc. are operated normally, and network traffic etc. are carried out.

(2) As to each server which belongs to a site, in case that there is a contract in site unit, and as to a server which is under contract in case that there is a contract in server unit, its operating condition is monitored and abnormality etc. are detected. For example, a usage rate of CPU, a usage rate of a memory, a usage rate and a vacant capacity of disc access and file system, a usage rate and an error rate of a network interface etc. are detected.

Also, in monitoring servers, it is possible to recognize that a designated process is operated on the system and whether or not the process is operated normally by the number of execution of the process. With regard to execution of an application, for exile, it is possible to monitor whether or not a file specific to the application is updated by checking a file renewal time and a file size.

Further, it is also possible to monitor monitoring runaway of the application. This may, for example, monitor a case that CPU time which the application is consuming is excessive. Also, it is possible to monitor a log of the application and occurrence of a bug

(3) According to need, a condition and abnormality relating to services which are provided in a server are monitored.

For example, it is monitored whether or not an interface (port) of services of the Internet is operated normally. This is realized by sending out a connection request to a port specific to the application and confirming whether or not there is a formal response.

Also, it is possible to realize monitoring of transaction quantity, monitoring of interpolation of URL/data/files.

Also, it is possible to measure presence and absence of a response and a response time, by actually accessing to URL and measuring a transfer time of HTML, by measuring a transfer tim of HTML files.

In monitoring these (1) - (3), there are both cases of a case that data for monitoring is given from the remote monitoring apparatus 20 to a server through the local IP region, and data responding to this is received by the remote monitoring apparatus 20 (monitoring through the local IP region) and a case that data for monitoring is given from the remote monitoring apparatus 20 to a server through the global IP region, and data responding to this is received by the remote monitoring apparatus 20 (monitoring through the global IP region).

For example, in a WWW server which is normally connected also to the global IP region, for monitoring HTTP services, the monitoring through the global IP region is carried out, and on the other hand, for monitoring a file system usage rate in a data base server which is normally connected only to the local IP region, the monitoring through the local IP region is carried out.

Also, the monitoring data processing part 48 has, a monitoring data judgment processing part 66 which receives data (monitoring data) which was obtained from the network monitoring processing part 60, the server monitoring processing 62 and the service monitoring processing part 64 and judges whether or not there occurs abnormality, an alarm notification processing part 68 which generates an alarm etc. for notifying to the monitoring center 16, a data display processing part 70 which generates verge data for displaying necessary information at the side of the remote monitoring apparatus 20, and a remote control processing part 72 which carries out processing necessary for operating the remote monitoring apparatus 20 according to an instruction from the monitoring center 16.

As to the processing of the remote monitoring apparatus 20 configured as such and processing in the related monitoring center 16, explanations will be added.

In a first embodiment, the following processing is mainly carried out.

(a) monitoring of the site by the remote monitoring apparatus, and notification of the alarm to the monitoring center (site monitoring/alarm notification),

(b) to display information necessary for the remote monitoring apparatus, according to an instruction from the monitoring center (data display), and

(c) operation of the remote monitoring apparatus by control from the monitoring center, and transmission of data in the remote monitoring apparatus to the monitoring center (control by the monitoring center),

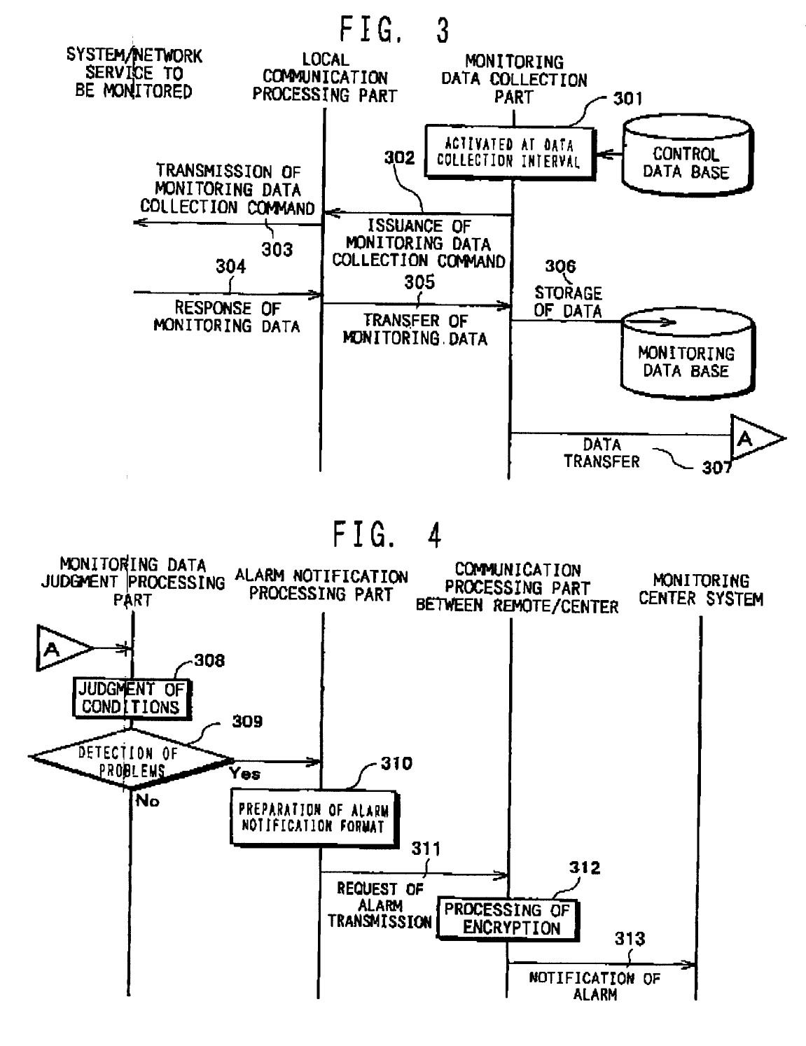

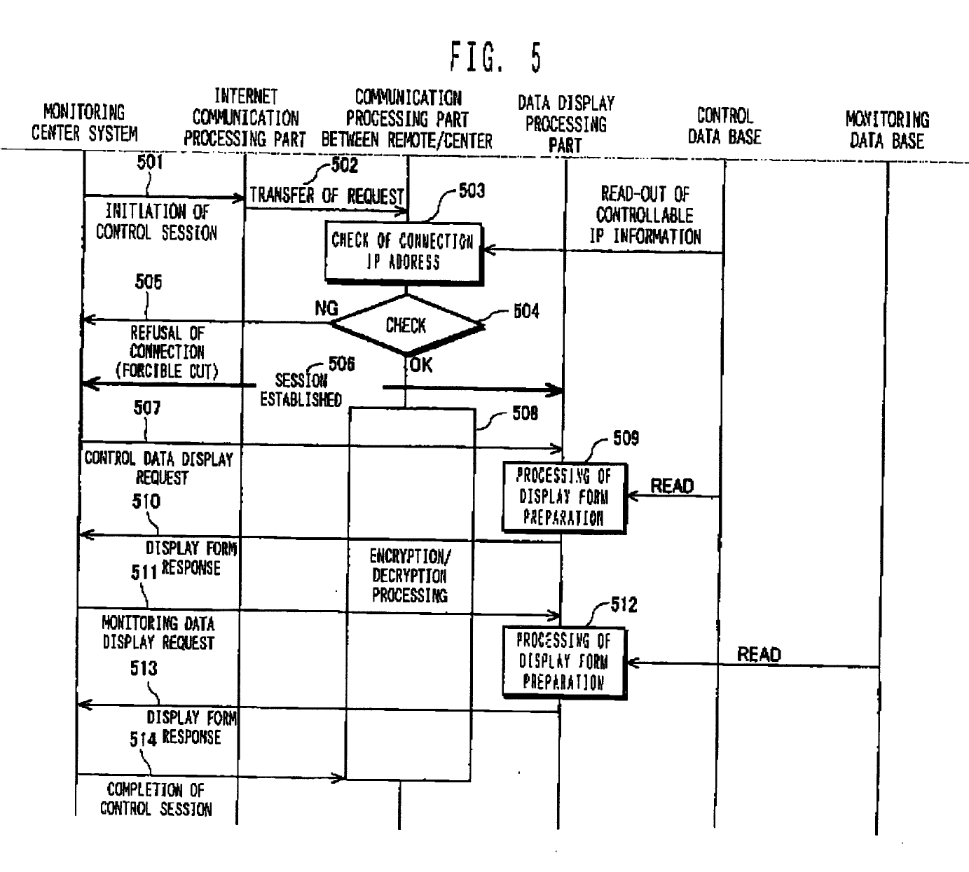

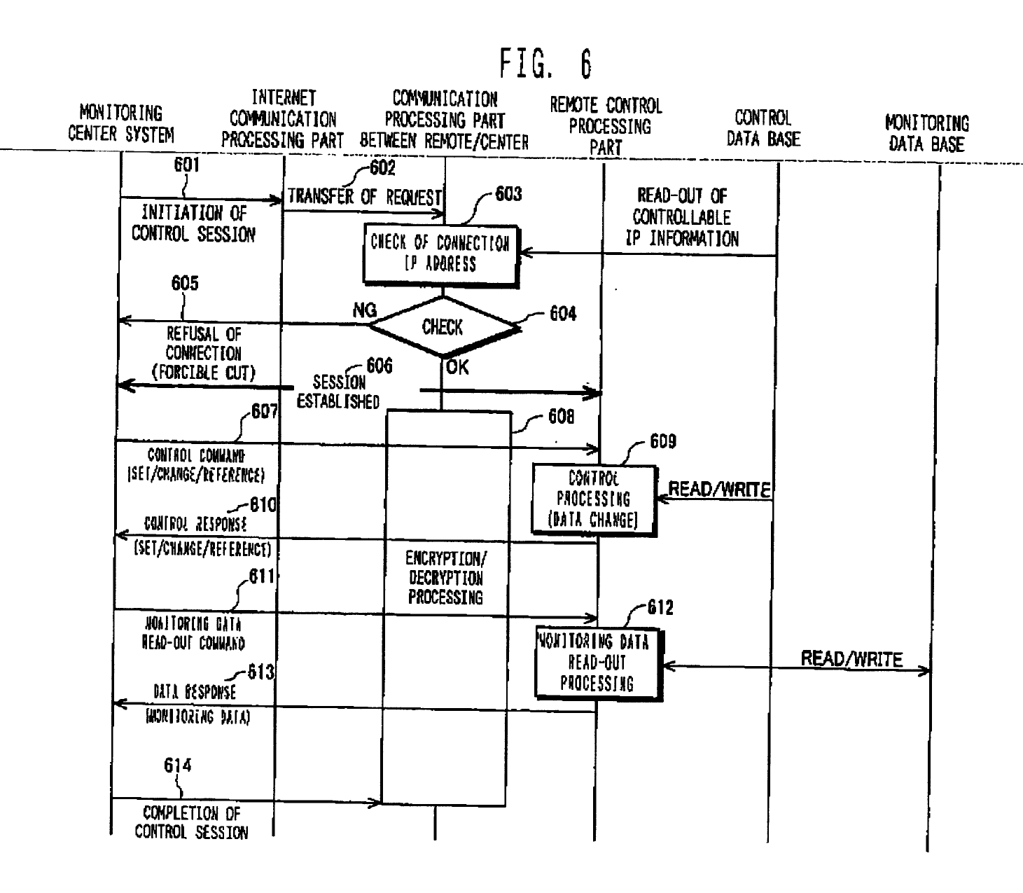

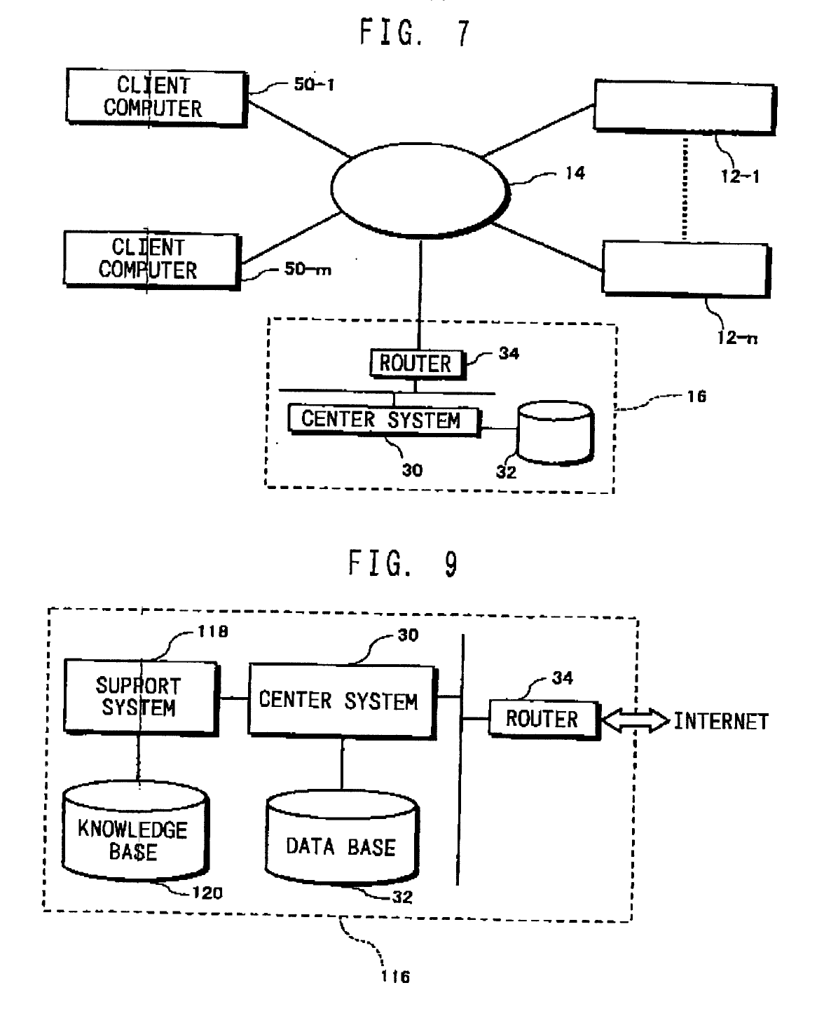

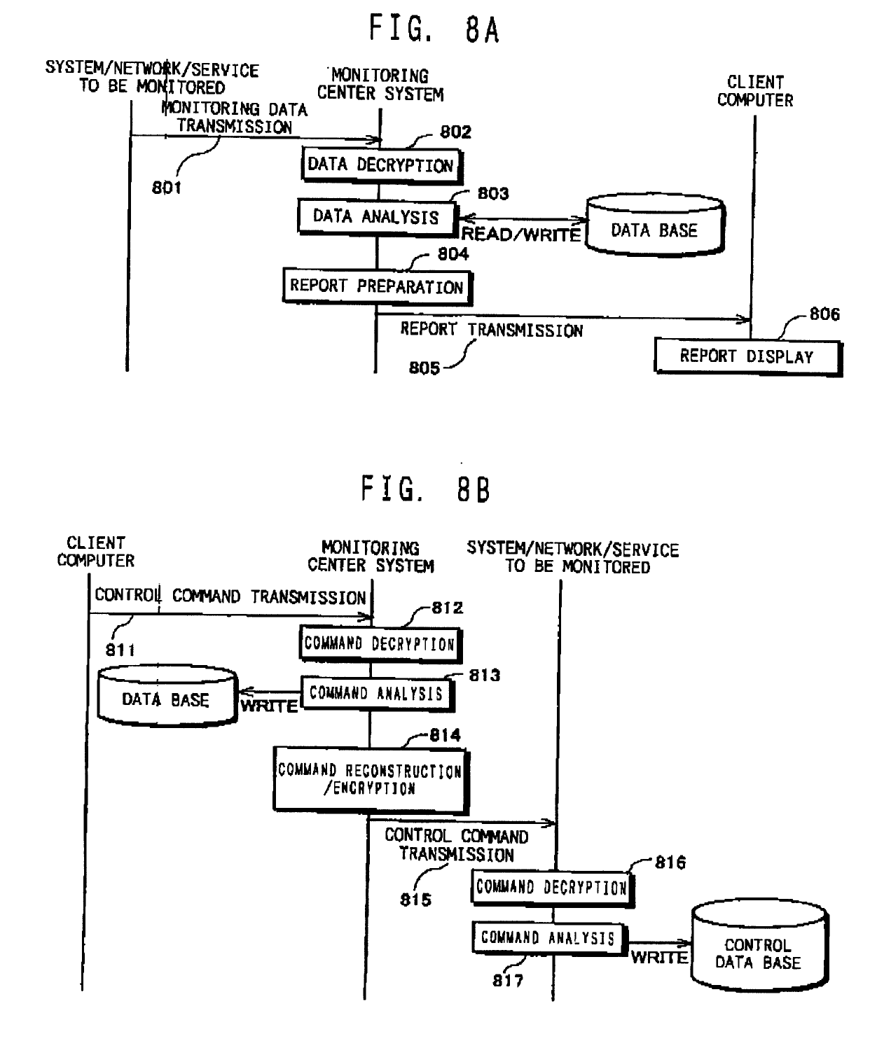

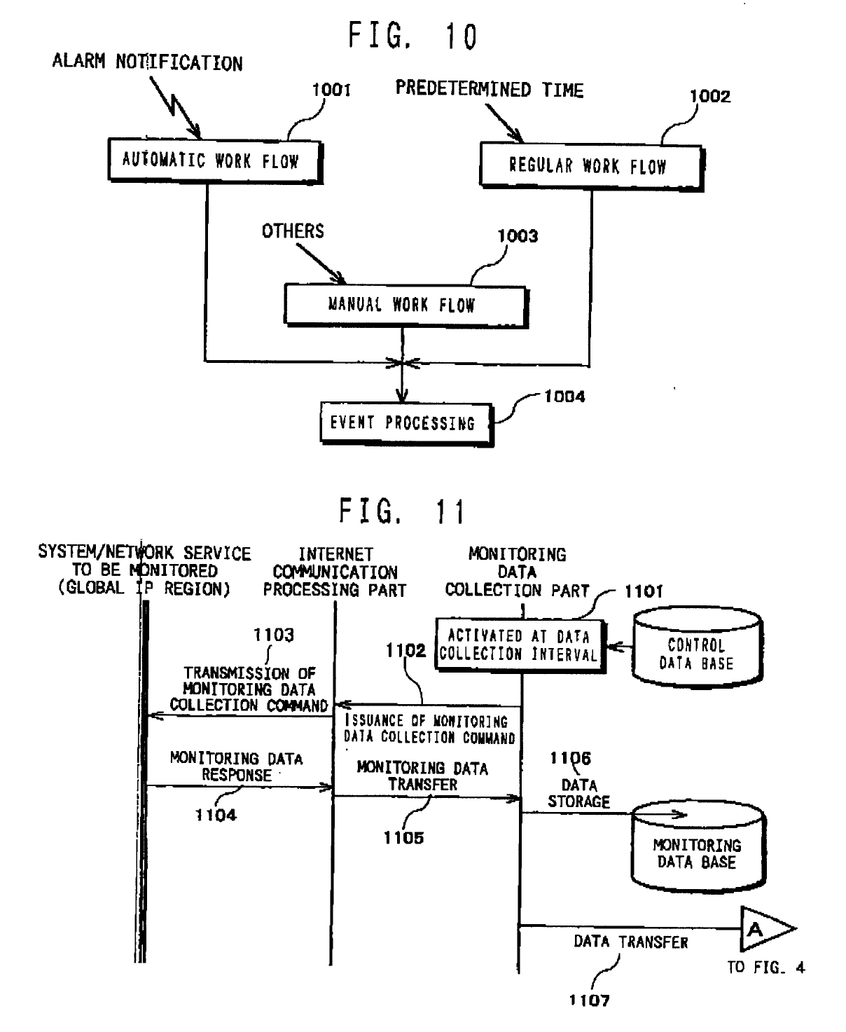

FIG. 3 and FIG. 4 are flow charts which schematically show processing of the site monitoring/alarm notification. In the processing shown in FIG. 3 and FIG. 4, the monitoring through the local IP region is carried out. As shown in FIG. 3, the monitoring data collection part 46 reads out various information relating to a predetermined monitoring program and set monitoring contents from the control DB 52 at a predetermined data collection interval (step 301). This monitoring program is for carrying out any one of items recited in the above (1) -(3).

For example, wit regard to certain server 22-i and a related network, if there is a necessity for carrying out items “A” and “IB” as monitoring items for the network, items “C”, “D” and “E” as monitoring items for the server, and items “IF” and “G” as monitoring items for services by the server, various information relating to the monitoring program for monitoring these items and monitoring contents is read out from the control DB 52 in compliance with the server 22-i. In addition, this monitoring timing may be set with respect to each server in the site, and may be set for carrying out the monitoring simultaneously to all servers in the site.

After that, the monitoring data collection part 46 issues a monitoring data collection command which instructs collection of the monitoring data to the local communication processing part 44 (step 302). The local communication processing part 44, in response to this, transmits the monitoring data collection command to the server 22 to be monitored through the local IP region (step 303). The local IP region and the server 22 return the predetermined data (monitoring data) to the local communication processing part 44 in response to the command.

The local communication processing part 44, when receives the monitoring data, transfers this to the monitoring data collection part 46. The monitoring data collection part 46 stores the monitoring data which shows operating conditions of the site and conditions of the network in a predetermined region of the monitoring DB 50, site by site and item by item (step 306) and transfers this to the monitoring data judgment processing part 66 of the monitoring data processing part (step 307).

As shown in FIG. 4, the monitoring data judgment processing part 66 refers to the control DB 52, checks out each monitoring data and judges whether or not data shows abnormality (step 308). In case that a problem was detected, in other words, in case that any abnormality was found (Yes at step 309 ), a point where the abnormality was found and its content are informed to the alarm notification processing part 68 in the monitoring data processing part 48. The alarm notification processing part 68, in response to this, generates alarm data according to a data format for alarm notification (step 310). The prepared alarm data is transmitted to the communication processing part 42 between remote/center (step 311), and encrypted in the encryption/decryption processing part 54 (step 312). After that, the connection IP address selection part 56 identifies an IP address of a place to which the alarm is notified (monitoring center), and the alarm data is transmitted from the Internet communication processing part 58 toward the place to be notified (step 313).

When the alarm data is transmitted to the monitoring centers 16, the central system 30, according to the alarm data, refers to the DB 32, obtains an instruction to be carried out by an operator and presents this to the operator. The operator, according to the instruction, studies the condition which is shown by the alarm data, and in case that its content is valid, i.e., there actually occurs a problem, takes necessary action such as notifying to a server operator etc.

Here, again, viewing the processing of the above-described FIG. 3 and FIG. 4, at the step 303, in the local IP address region, various monitoring processing to the local IP address region, the server and services which are provided by the server is carried out. The site is a region which is separated by a fire wall from outside (global IP region such as the Internet etc.). On this account, in the local IP address region, it becomes possible to transmit and receive data without encrypting data which is given to the server etc. for monitoring and response data from the server etc. and safely.

On the other hand, at the step 313, in the global IP address region, under an environment exposed to outside, data is supplied from the remote monitoring apparatus 20 to the monitoring center 16. Accordingly, in this case, in the remote monitoring apparatus 20, data to be transmitted is encrypted (see step 312).

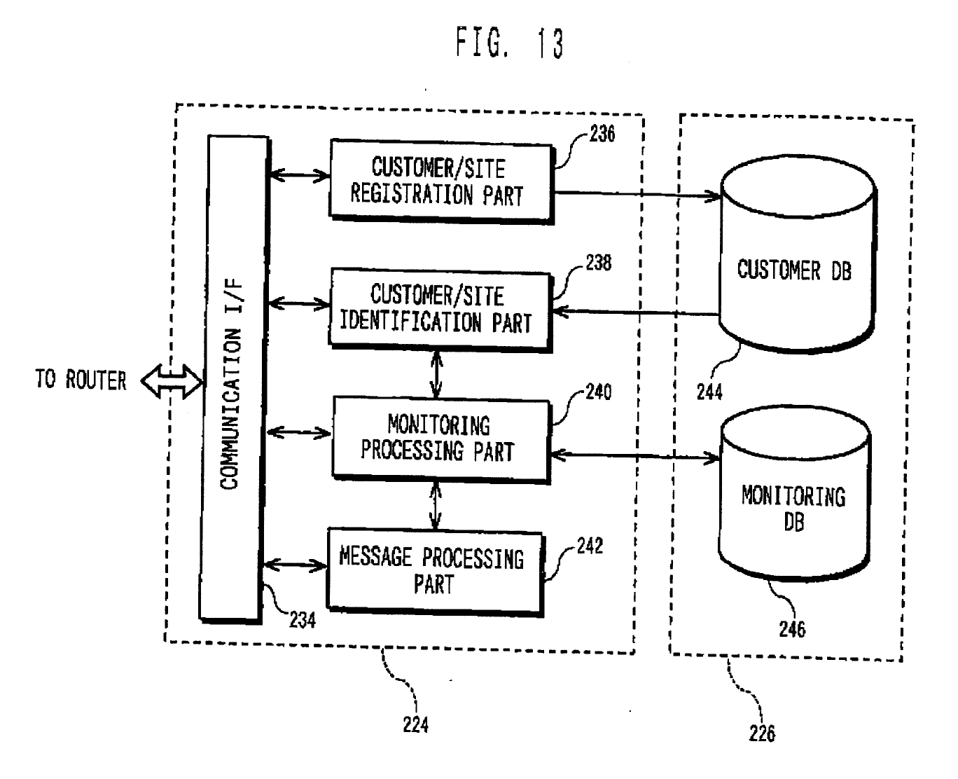

The monitoring through the global IP region can be carried out in approximately similar manners. FIG. 11 is a flow chart which shows monitoring processing through the global IP region. Although FIG. 11 is all most the same as processing in FIG. 3, it differs on a point that what receives the monitoring data collection command from the monitoring data collection part 46 and sends out this to the network is the Internet communication part 58. Accordingly, at step 1103, the Internet communication part 58 gives predetermined data to the server 22 connected to the global IP region through the global IP region. Also, at step 1104, the Internet communication part 58 is designed to receive data which was sent out from the server 22 through the global IP region.

Next, in reference to FIG. 5, explanations will be added as to data display processing. The data display processing is carried out by an instruction from the monitoring center 16 so as to display results of monitoring etc. on a screen of a display device of the central system 30. For example, as to monitoring of the servers, memory consumption quantity, disc consumption quantity, the number of process, size of process etc are included in contents to be notified. Also, as to monitoring of the services, information showing whether the services are normally provided, time from a service request until completion of a response (response time) etc. is included. Besides, control data showing a server as an object for monitoring, item to be monitored, a monitoring interval, or conditions of alarm occurrence etc. may be presented on the screen of the display device (not shown) of the central system 30.

When the Internet communication processing part 58 receives data which shows an initiation of a control session from the central system 30 of the monitoring center 16 (step 501) it transfers the received data to the connection IP address selection part 56 (step 502).

The connection IP address selection part 56 searches the control data base 52 to judge whether or not the control session due to the IP address which requested for the connection is valid (step 503). In short, in this processing, whether or not it is okay for the remote monitoring apparatus 20 to be controlled is judged by a device having the IP address which requested for the connection.

At the step 504, in case that it was judged to be NG, the Internet communication part 58 cuts a line forcibly and refuses the connection (step 505). on the other hand, at the step 504, in case that it was judged to be OK, a session between the monitoring center 16 and the remote monitoring apparatus 20 (in more detail, between the data display processing part 70) is established (step 506).

When the session is established, the system 30 of the monitoring center 16 gives an instruction (control data display request) to the remote monitoring apparatus 20, so as to display a predetermined one out of the control data (step 507). Then, communications between the monitoring center 16 and the remote monitoring apparatus 20 are all carried out by encrypted data. Accordingly, encrypted data which was transmitted from the monitoring center 16 through the global IP region is decrypted at the encryption/decryption processing part 54, and on the other hand, data to be transmitted from the remote monitoring apparatus 20 to the monitoring center 16 is encrypted at the encryption/decryption processing part 54 (step 508).

The data display processing part 70, in response to the reception of the control data display request, reads out necessary data from the control DB 52 and prepares data of display images (step 509). This data is, so as to be able to be displayed by the central system 30, prepared in for example, HTML format. Data of the display images (display image data) is transmitted through the communication processing part 42 between remote/center to the system 30 of the monitoring center 16 (step 510).

After that, the system 30 of the monitoring center 16, so as to display the predetermined one out of the monitoring data, gives the instruction (monitoring data display request) to the remote monitoring apparatus 20 (step 511). The data display processing part 70, in response to the reception of the monitoring data display request, reads out necessary data from the monitoring DB 50, and prepares data of display images (display image data) (step 512). This image is also transmitted to the system 30 of the monitoring center 16 through the communication processing part 42 between remote/center (step 513).

The monitoring center 16, according to need, transmits the control data display request (step 507) and the monitoring data display request (step 511) to the remote monitoring apparatus 20. After necessary display image data has been completed to be received, the system 30 of the monitoring center 16 transmits data which shows a completion of the control session to the remote monitoring apparatus 20, and cuts the communication (step 514).

Next, in reference to FIG. 6, explanations will be added as to control processing by the monitoring center. In addition, since step 601 - step 606 of FIG. 6 correspond to the steps 501 - 505 and the step 508 of FIG. 5, explanations will be omitted.

After the session was completed (step 606), the system 30 of the monitoring center transmits a control command to the remote monitoring apparatus 20 (step 607). The control command is a command for changing the above-described control data etc.

The remote control processing part 72, according to the control command, sets or changes the control data in the control data base 52, or reads out predetermined control data (step 609). After that, a response which shows that the set/change of the control data was completed, or the control data which was read out (control response) are transmitted, through the communication processing part 42 between remote/center etc., to the monitoring center 16 (step 610).

Also, when the system 30 of the monitoring center 16 instructs a read-out of predetermined data in the monitoring DB 50 (monitoring data read-out command) (step 611), the predetermined monitoring data is read out from the remote control processing part 72 (step 612), and these are transmitted to the monitoring center 16 as data response (step 613).

When a necessary response is received, the system 30 of the monitoring center 16 transmits the data which shows the completion of the control session to the remote monitoring apparatus 20, and cuts the communication (step 614).

As just described, according to the embodiment, disposed is the remote monitoring apparatus which is connected to the monitoring center 16 through the global IP region and connected to the servers in the site through the local IP region, and the remote monitoring apparatus carries out a communication with high security which was encrypted between it and the monitoring center, and on the other hand, between it and the server in the site, data communication for monitoring in detail operating conditions of the servers and conditions of providing services etc. is carried out. Between the global IP region and the local IP region, it is completely separated. Accordingly, detailed monitoring in the site can be realized, and on the other hand, on the occasion of notifying this to the monitoring center, it becomes possible to realize data communication with high security.

### Second Embodiment

Next, explanations will be added as to a second embodiment of the invention. In the second embodiment, in the monitoring center 16, without passing through an operator, it is possible to notify the operating conditions of the server in the site to a managing operator of the site and the server. FIG. 7 is a block diagram which shows a structure of the monitoring system according to the second embodiment. In FIG. 7, a structure of each site 12 is similar to that of the first embodiment. Also, the structure of the monitoring center 16 is similar to that of the first embodiment, except for such a point that processing which is carried out at the central system 30 is added.

In the second embodiment, predetermined data is designed to be transferred from the monitoring center 16 to a computer for the managing operator of the site and the server etc. Also, it is designed that, receiving information from the computer of the managing operator, the remote monitoring apparatus 20 can be controlled. Hereinafter, in the specification, the computer of the managing operator of the site and the server etc. is also referred to as a client computer. In this embodiment, by procedures according to FIG. 3 and FIG. 4, encrypted monitoring data etc. is transmitted to the monitoring center 16.

The monitoring center 16, by procedures shown in FIG. 8A, can convert the monitoring data from the remote monitoring apparatus 20 which was applied to the monitoring center 16 into a format which is easily viewable for a client side, which can be presented. On the other hand, a client computer 50, as shown in FIG. 8B, gives control data which controls the monitoring items etc. to the monitoring center 16, and can set monitoring to the remote monitoring apparatus 20 as desired.

For example, as shown in FIG. 8A, when the monitoring center 16 receives the monitoring data which was sent from the remote monitoring apparatus 20 disposed in the site (step 801), the monitoring data is decrypted (step 802), and which remote monitoring apparatus 20 the data come from (i.e., which site for monitoring relates to the result), and which server and which function were monitored to obtain the result etc. are identified (step 803). Also, the monitoring data is stored in the data base 32.

After that, the central system 30, based upon information obtained, analyzes data to be transmitted to each client, and prepares a report for each client (step 804). the finished report is transmitted, through the global IP region, to a predetermined client computer (step 805). In the client computer 50, the obtained report is displayed on the screen of the display device (step 806). By this, it becomes possible to notify the managing operator of the site and the server which exist away from the site of the operating conditions of the site and the server in a way easy to understand. In addition, communications between the monitoring center 16 and the client computer 50 (see step 805) may utilize a similar encryption system to the communication of the monitoring data (see step 801), and may utilize other encryption system. Or, if an authentication of an access is carried out between the monitoring center 16 and the monitoring center 16, the encryption system may not be utilized.

In addition, in the above-described processing, it goes without saying that the transmission of various data from the remote monitoring apparatus 20 to the central system 30, and the preparation of the report and the transmission of the report to the client computer 50 may not be carried out continuously. For example, the preparation and the transmission of the report may be automatically carried out at a predetermined interval, or, maybe carried out according to a request of the client computer 50.

Next, explanations will be added as to procedures in a case that the remote monitoring apparatus 20 is controlled from the side of the client computer 50. In this case, the control command is sent from the client computer 50 to the monitoring center 16 (step 811). This control command is one for changing etc. control data which contains a name of a server as an object for monitoring, items to be monitored, a monitoring interval, conditions of alarm occurrence etc. This control command is also encrypted according to the encryption system between the client computer 50 and the remote monitoring apparatus 20.

In the monitoring center 16, the control command is decrypted (step 813), and the command is analyzed (step 814). Here, in case of necessity, the data base 34 is renewed. Also, the IP address of the remote monitoring apparatus 20 as a place to which the control command is transmitted is identified. After that, this data is again encrypted (step 814), and transmitted to the remote monitoring apparatus 20 of a predetermined site as the control data (step 815).

The remote monitoring apparatus 20 decrypts the control command (step 816), analyzes the command, and renews the control DB 52 (step 817). The remote monitoring apparatus 20, according to conditions etc. which were changed by the control command, can carry out monitoring of the server in the site.

According to the embodiment, a report based upon the monitoring data from the remote monitoring apparatus 20 is prepared automatically in the monitoring center 16 or according to a request from the client computer 50, and transmitted to the client computer 50. Also, the control command from the client computer is transmitted, through the monitoring center 16, automatically to the predetermined remote monitoring apparatus 20, and it is possible to set the monitoring content in the remote monitoring apparatus 20 as desired.

### Third Embodiment

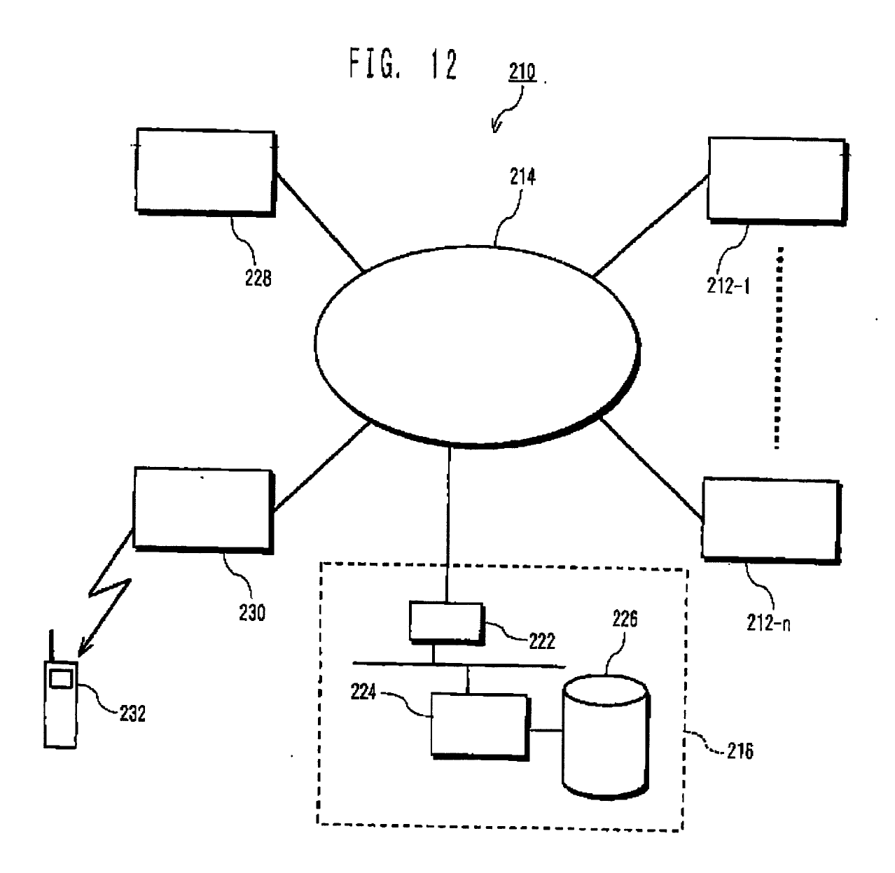

Next, explanations will be added as to a third embodiment of the invention. In this embodiment, a system 116 of the monitoring center is constructed as an expert system which used a knowledge base, and, it is configured such that, even in case that an operator of the monitoring center does not familiarize, works can be carried out appropriately. FIG. 9 is a block diagram which shows a structure of a monitoring center according to the third embodiment. In addition, in FIG. 9, the same signs are attached to the same structural portions as those of the monitoring center shown in FIG. 1.

As shown in FIG. 9, the monitoring center 116 has a support system 118 and a knowledge base 120 in addition to the central system 30, the database 32 and the router 34. The support system 118, based upon monitoring data which were given from the remote monitoring apparatus 20, ref refers to the knowledge base, and presents information which shows conducts to be carried out by an operator to the operator.

In more detail, in this embodiment, in the following case, the support system 118 is activated, and a predetermined event is prepared and can be transmitted to the central system 30. (1) Automatic work flow (stop 1001 of FIG. 10)

In case that an alarm is contained in monitoring data from the remote monitoring apparatus 20, it is activated. For example, the content of the alarm is analyzed, a work instruction of the operator which coincided with the content is selected, and this is presented to the operator. The operator confirms, according to the work instruction presented, the content of the alarm, and can judge whether or not there occurs a trouble in fact. In case that the trouble occurs, an event (trouble ticket) is prepared. The event means a unit in which data relating to troubles which were verified by the work flow was integrated, and contains data which shows time when the trouble occurred, a name of an object to be monitored in which the trouble occurred, a place to be notified, a current status etc. (2) Regular work flow (step 1002)

An instruction of regular jobs of an operator is prepared. At a time interval selected in advance, the job instruction is automatically prepared. The job instruction contains to display a designated site or a page obtained from the server and to confirm whether a logo etc. are normally displayed by an operator's visual observation. The operator may carry out necessary jobs according to the job instruction, and may input necessary information etc. Also, in case that an exception occurred, the event (trouble ticket) is prepared. The exception in the regular work flow means, for example, that a matter other than predetermined conditions occurred, such as a case that the logo is not displayed correctly in the above-described page and so on. (3) Manual event work flow (step 1003)

As to job instructions which are not prepared in the above-described work flow, the instructions are prepared individually. Since the job instructions here are newly added, ones which are incorporated in the above-described automatic work flow and the regular work flow correspond to them mainly. Here also, in case that it is contemplated that the troubles etc. occur, the event is prepared.

In case that, by this means, the event was prepared, the operator, through the use of the support system 118, carries out necessary event processing (step 1004). For example, in this processing, in response to the operation of the operator, the support system 118, in reference to the knowledge base 120, displays other parties (address to be notified) to be notified of the trouble and abnormality etc. from one with higher priority, and from the one with higher priority, transmission of information which shows the trouble and the abnormality is requested to the system 30 of the monitoring center 16.

As just described, according to the third embodiment, with respect to each work flow, jobs to be carried out by the operator are instructed, and the operator may carry out an input of information and the job according to an instruction of the job. Accordingly, even if he/she is not a person of skill, it is possible for him/her. to carry out the monitoring work appropriately.

### Fourth embodiment

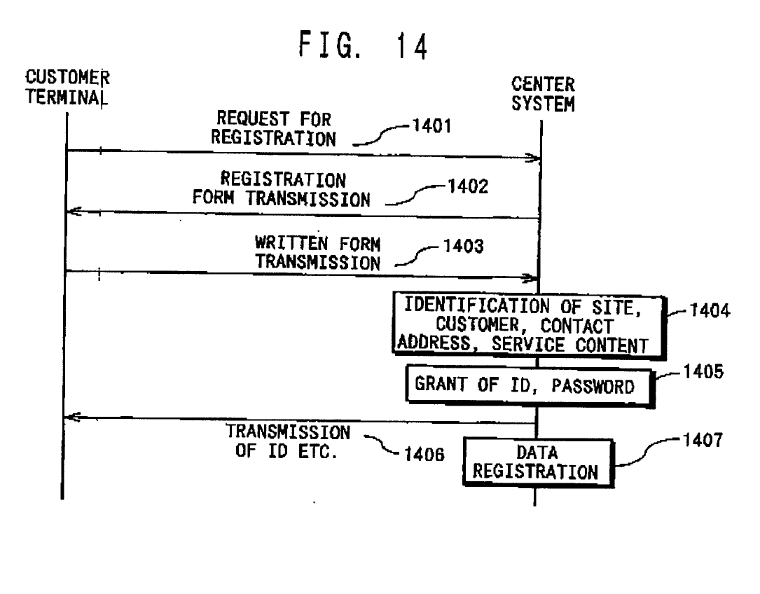

Next, explanations will be added as to a fourth embodiment FIG. 12 is a block diagram which shows a structure of a monitoring system according to a fourth embodiment of the invention. As shown in FIG. 12, in a monitoring system 210, various sites 212-l,. .,212-n are connected to the Internet 214. Accordingly, the above-described site 212 is designed to be able to provide various services and information to personal computers etc. (not shown) through the Internet 214. Also, to the Internet 214, a monitoring center 216, which is for monitoring the above-described site 212 connected through the Internet 214, is connected.

In this embodiment also, in the same manner as in the first and the second embodiments, one server or more is connected to one site. It is not applied only to one server corresponding to one content provider, and for example, there is a case that a plurality of content providers exist in one server, and on the other hand, there is also a case that one content provider utilizes a plurality of servers. Accordingly, also in this fourth embodiment, the site means a region which is separated by a fire wall from the global IP region, and which has servers connected each other through the local IP region.

The monitoring center 216 has a router 2 22, a central system 224 and a data base 226. In the data base 226, information of a customer who is a site operator and operating information of the site etc. are stored.

Further, in the embodiment, to the Internet 214, a computer system 228 of the site operator (customer) and a server and a gateway of a telephone service business proprietor (referred to as “telephone service server 230”) are connected. It is designed such that, to a portable terminal 232 such as a portable telephone and PDA etc., through the telephone service server 230, information from the Internet can be transmitted.

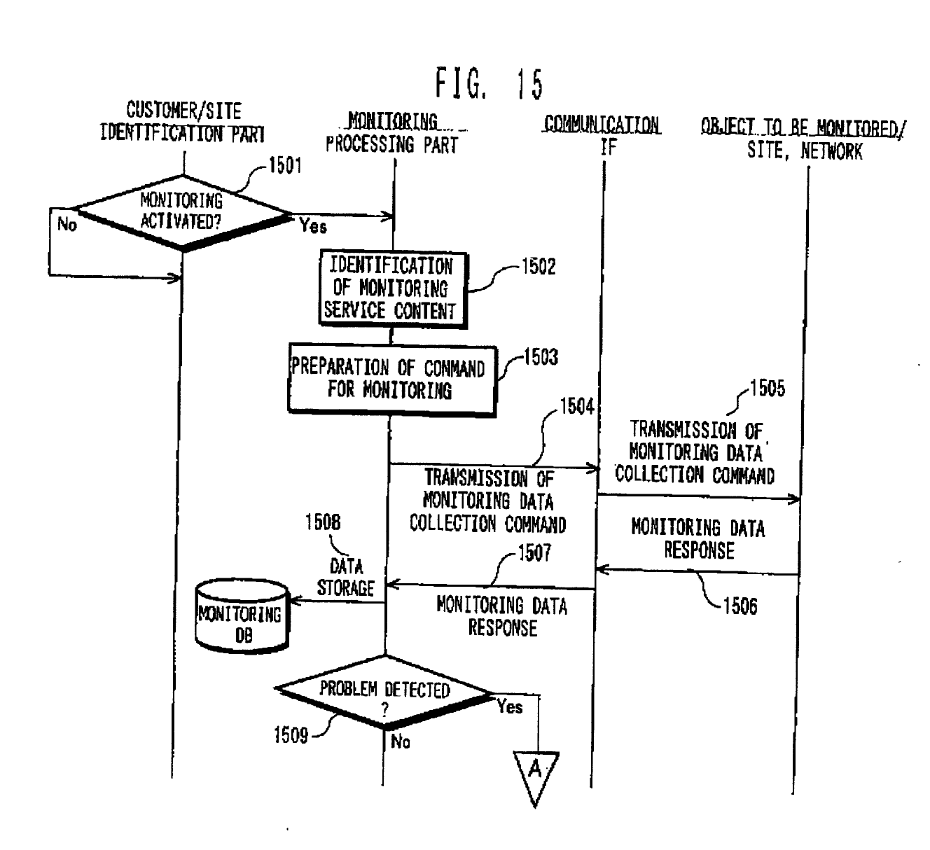

As shown in FIG. 13, the central system 224 has a communication interface (I/Flow) 234 which controls data transmission and reception to and from outside through the router 222, a customer/site registration part 236 which registers various information relating to a site and a customer as an operator of the site, a customer/site identification part 238 which identifies an IP address etc. to which data should be transmitted on the occasion of monitoring and notification, a monitoring processing part 240 which carries out processing for monitoring a site according to need, and a message processing part 242 which prepares a message which should be transmitted to a customer. Also, the data base 226 has a customer DB 244 which stores information identifying a customer and a site (for example IP address) and information showing a content of a monitoring service of a site, and a monitoring DB 246 which stores a monitoring result of the site and a command from the customer.

In the monitoring system 210 configured like this, as to a request of remote monitoring by an operator of a site and processing of its registration, in reference to FIG. 14, explanations will be added. In addition, in FIG. 14, it is configured that a registration is requested from the portable terminal 232 to the monitoring center 216 but it is not limited to this, and it may be a registration from the personal computer 228 of the operator of the site. In this case, it goes without saying that the portable terminal 232 may be a contact address of the customer.

First, the operator operates keys of the portable terminal 232, opens a communication path with the central system 224 of the monitoring center 216, and transmits information which shows a request for registration from the portable terminal 232 to the central system 224 (step 1401). The customer/site registration part 236 of the central system 224, in response to this, transmits a predetermined registration form to the portable terminal 232 of the operator through the communication I/F234(step 1402). In the registration form,information which identifies the site and the server (for example, an IP address of a site or a specific server in the site), information which identifies the customer (name of the operator, number of the contact address), contents of the monitoring services etc. are included. For example, in case that an entire site is designated, a server which configures the site may be able to be identified. Of course, it goes without saying that a single server only or a plurality of servers may be identified.

Also, as the monitoring service, in this embodiment, the followings are available. (1) Monitoring of access time

For example, it is possible to judge that a load of a network and a server is heavy. (2) Refusal of access to server

By this, it is possible to judge a trouble of Internet connection line, a trouble of LAN, down of a router, server down etc. (3) Presence and absence of service-down at the time of operation of server

By this, it is possible to judge abnormality of a fire wall (setting error), down of processes which carry out services such as a mail and a web etc. Further, (4) It is possible to judge presence and absence of renewal of data (file) of services of a server and applications and contents.

In addition, the content of the services includes a timing (for example, duration, time etc.) for activating the monitoring service, other than information which shows whether any one of the above-described monitoring services should be carried out.

An operator operates key of the portable terminal 232, and enters predetermined information in the registration form. The written registration form is transmitted from the portable terminal 232 to the central system 224 (step 1403). The customer/site registration part 236 of the central system 224 identifies information which identifies a site, information which identifies a customer, contents of the monitoring services etc. (step 1404). Also, the customer/site registration part 236 gives a customer ID and a password of the customer (step 1405), and transmits the customer ID etc. to the portable terminal 232 (step 1406). In addition, it goes without saying that the password may be notified to the customer by other means such as mailing at later time.

After that, the customer/site registration part 236 stores information which was identified at the step 1404 in the customer DB 244 in association with corresponding customer (step 1407). By this, the registration of the customer and the site or, the server as an object to be monitored is completed.

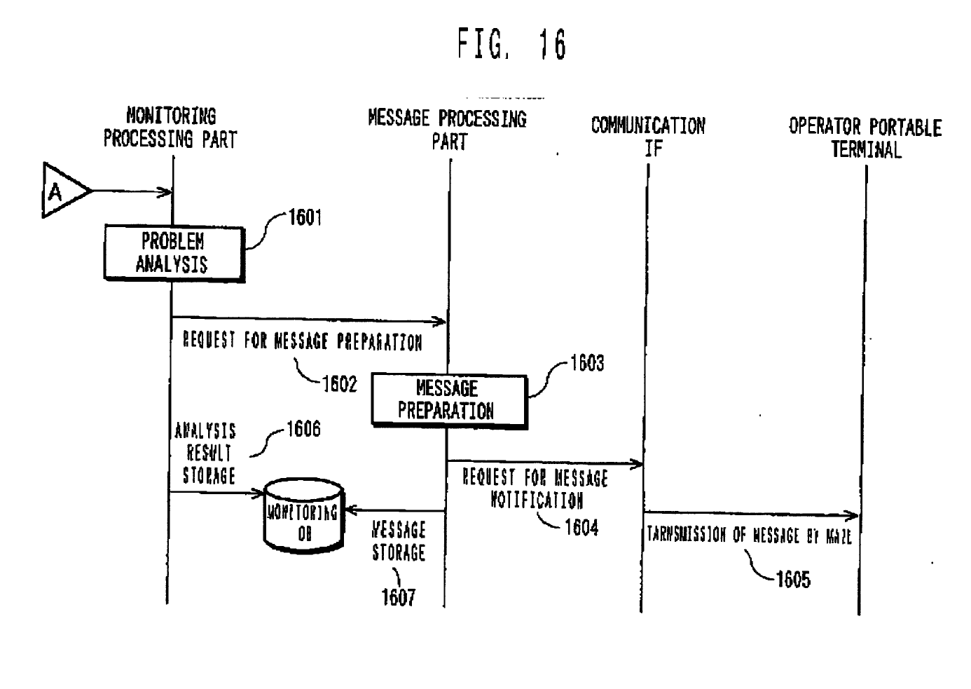

By the registration shown in FIG. 14, monitoring of the site or the server is realized according to the service content. FIG. 15 and FIG. 16 are flow charts which show monitoring processing of the site and the server according to the embodiment. The customer/site identification part 238 of the central system 224, in reference to the service content with respect to each customer which was stored in the customer DB 244, judges whether or not monitoring of a certain site or server should be initiated (step 1501). In case that the monitoring of any site or server should be carried out (Yes at step 1501), the monitoring processing part 240 receives the service content relating to the site or the server as the object to be monitored, from the customer/site identification part 238 (step 1502), and based upon the content, a command to be sent to the object to be monitored is prepared (step 1503).

A command which was prepared at the monitoring processing part 240 (monitoring data collection command) is sent to a site, a server or a network as the object to be monitored through the communication I/Flow 234 (steps 1504, 1505).

The site, server etc. (for example, the site 212-1) which became the object to be monitored receives the monitoring data collection command which was given through the Internet 214 as the global IP region, carries out the processing responding to the command, and transmits the monitoring data to the monitoring center 16 (step 1506). The monitoring data which was received through the communication I/Flow 234 of the central system 224 is transmitted to the monitoring processing part 240 (step 1507)

The monitoring processing part 240 stores the received monitoring data in the monitoring DB 246 in association with the customer (step 1508), and judges whether or not a point at issue exists (step 1509). In case that it was judged that there is no point at issue in particular (No at a step 1509), processing relating to the site or server is completed.

On the other hand, in case that it was judged that there is a point at issue (Yes at the step 1509), further, processing shown in FIG. 16 is carried out.

The monitoring processing part 240, by analyzing the monitoring data in detail, judges what kind of points at issue occur (step 1601). For example, (1) in case that access time of the site is excessively long, it is judged that a load of the network and the server is heavy. Alternatively, (2) in case that an access of the server was impossible, and (3) even in case of service down, it is possible to judge that there is a possibility that corresponding point at issue occurs.

After the judgment like this, the monitoring processing part 240 transmits a request for preparing a message to which a point at issue (trouble) that is probable to occur at the site or the server was added to the message processing part 242 (step 1602). The message processing part 242, in response to this, prepares a necessary message (step 1603), and requests the communication I/Flow 234 to send this toward the portable terminal 232 of the registered customer (operator) (step 1604). The communication[nication I/Flow 234, in response to the above-described request, sends a message prepared by mail, toward the portable terminal 232 of the customer (operator) (step 1605). In the portable telephone 232, when receives a message, displays this on the screen of the display device. For example, if a push mail is utilized, it becomes possible to transmit the message to the operator without time lag.

By this means, it becomes possible for the operator to receive a notification at his/her own portable terminal 232 when a trouble of the site or the server occurs.

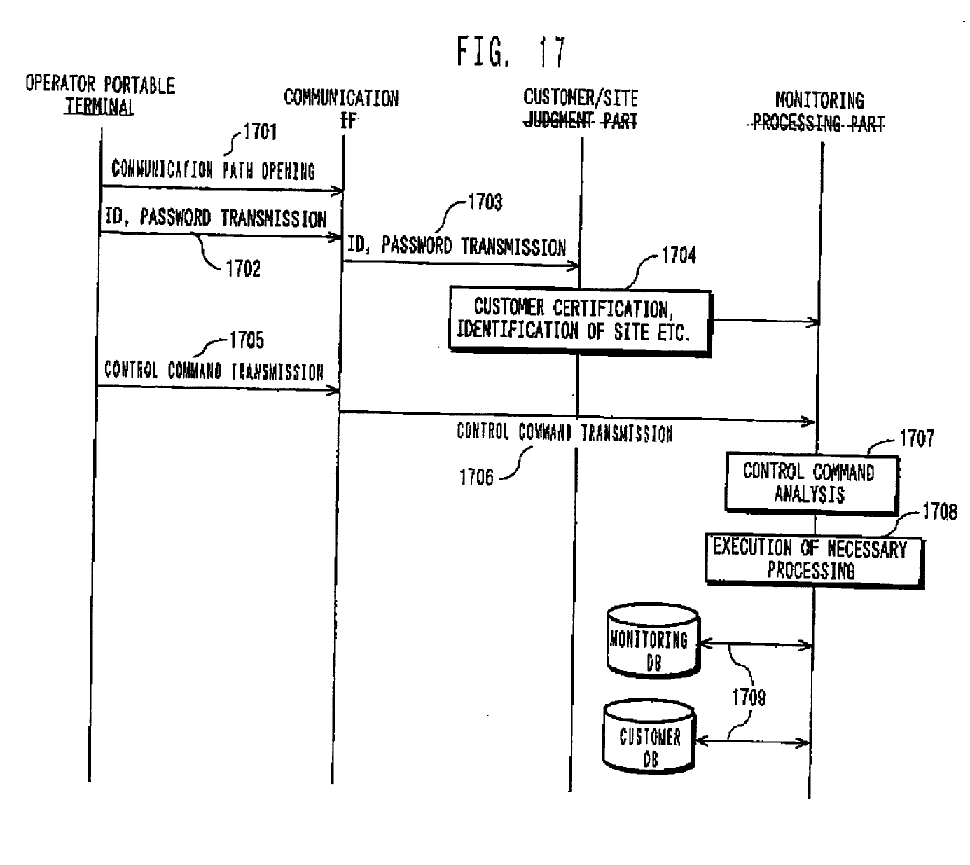

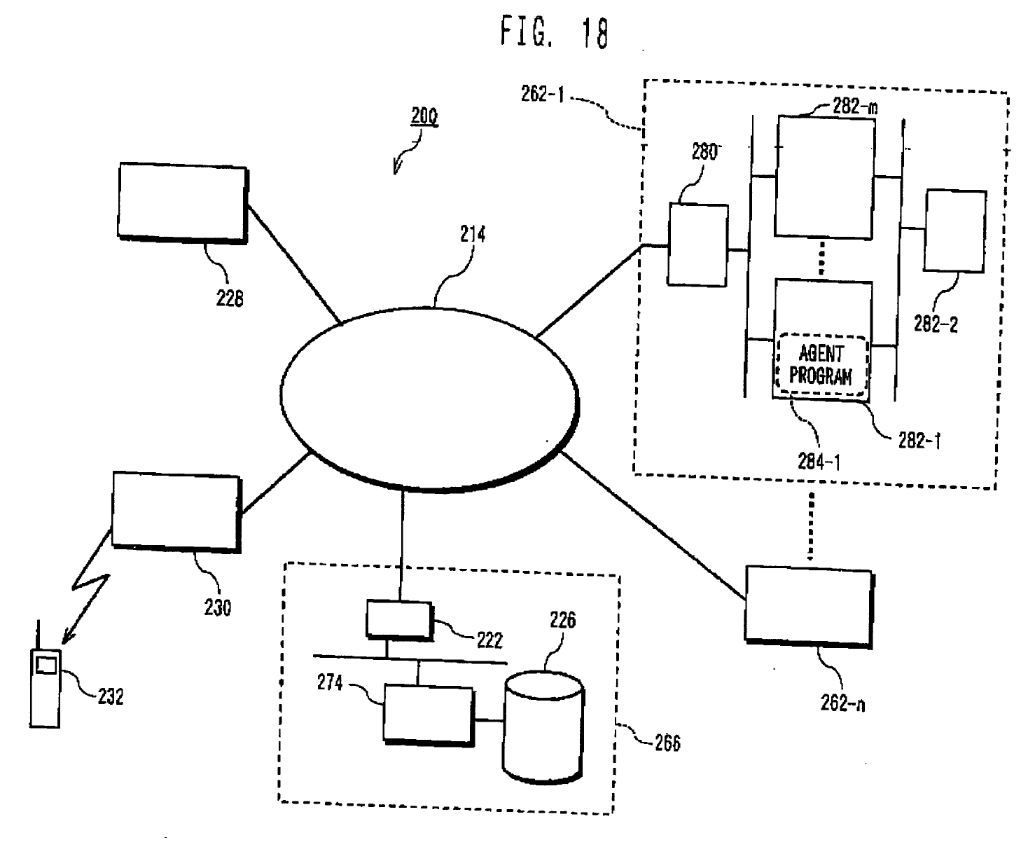

By sending the control command from the operator to the monitoring center 216, it becomes possible to refer to the monitoring data stored in the monitoring center 216 relating to the site or the server which himself/herself is operating, or to give an instruction so as to carry out the monitoring of the site or the server, or to change the registration content such as the service content etc. FIG. 17 is a flow chart which shows transmission of the control command from the portable terminal of the operator to the monitoring center and processing which comes up with this.

First, when a communication path of the portable terminal 232 of the operator and the central system 224 of the monitoring center 216 is opened (step 1701), the customer ID and the password are transmitted from the portable terminal 232 to the communication I/Flow 234 of the central system 224 (step 1702). The customer/site identification part 238 which receives these from the communication I/Flow 234 (step 1703), in reference to the customer DB 244, certifies the customer and identifies a relevant site or server (step 1704). In addition, in case that, at the step 1704, the certification of the customer failed, for example, because of inconsistency of the password, the processing is finished.

After that, the control command is transmitted from the portable terminal 232 of the operator to the monitoring processing part 240 through the communication I/Flow 234 (steps 1705, 1706). This control command includes, for example, a transmission request of data (monitoring data) which shows in more detail conditions of the server and the site as the object to be monitored, an activation request of the monitoring of the server and the site, change of the registered content containing the contact address of the operator and the service content, a transmission request of specific data (monitoring data collection command) to the server and the site etc.

The monitoring processing part 240, in response to the reception of the control command, analyzes the control command received (step 1707), and carries out necessary processing (step 1708). If necessary, the monitoring processing part 240 can read out data from the customer DB 244 and the monitoring DB 246, or can renew data (see step 1709).

For example, if it is necessary to transmit the monitoring data collection command to the object to be monitored, processing from the steps 1502 to 1509 of FIG, 15, in some cases, processing of FIG. 16 in addition to this is carried out.

As just described, according to the fourth embodiment, the monitoring center 216 sends the monitoring data collection command to a predetermined site or server through the Internet which is the global IP address region, and receives data (monitoring data) from the site or the server as the object to be monitored, further the network in addition to this, analyzes this, and notifies this to the portable terminal etc. of the operator which is the customer, in case of necessity such as occurrence of the trouble in the site and server etc. Accordingly, it becomes possible to appropriately notify the abnormality of the site and the server wherever the customer is.

Also, even in case that the abnormality and the trouble occurred in the site and the server or its neighboring network, this is detected by the monitoring (transmission of the monitoring data collection command) from the monitoring server 216, and it becomes possible to notify to the operator.

### Fifth Embodiment

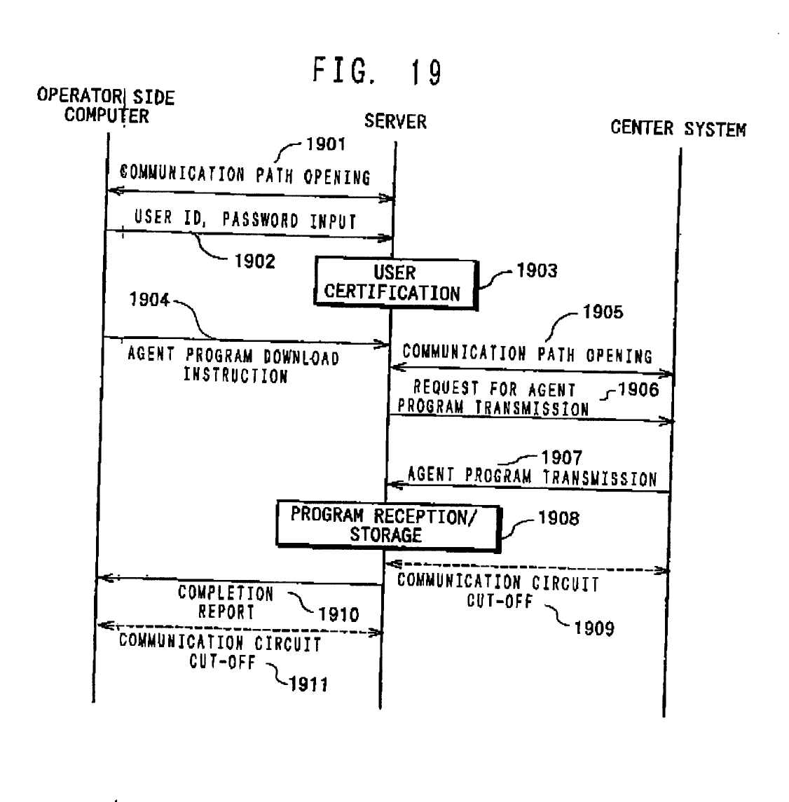

Next, explanations will be added as to a fifth embodiment of the invention. In the fifth embodiment, it becomes possible to monitor the server etc. in more detail by downloading an agent programs in the server in the site and activating the agent program. FIG. 18 is a block diagram which shows a structure of a monitoring system according to the fifth embodiment. In FIG. 18, the same signs are attached to the same structural portions as those of FIG. 12. In this monitoring system 250, a plurality of sites 262-l - 262-n, and a monitoring center 266 are connected to Internet 214. The site (for example, see the reference numeral 262-1) has a router 280 and one or more servers 282-l - 282-m which are connected to the router. It is designed such that this server 282 can download the agent program (see reference numeral 284-l) which is given from the monitoring center 266, and also, according to a command from the monitoring center 266, can operate the agent program.

Also, the data base 226 of the central system 274 of the monitoring center 266 accommodates the agent program, and it is configured that, in response to the registration by the operator and the transmission request of the agent program, it can send the agent program to the server 282.

In the embodiment, it is configured that the agent program can monitor processing conditions inside the server such as processing of CPU of the server 282 etc., and besides it, can monitor the occurrence etc. of the abnormality in the local IP region 236. In more detail, the agent program according to the embodiment is capable of monitoring as follows. (1) By monitoring the network of the local IP region 236, abnormality on the network is detected. In more detail, whether or not a LAN device, a router, a hub etc. are normally operated, monitoring of the network traffic etc. are carried out. (2) By monitoring operating conditions of the server 282, abnormality etc. are detected. For example, a usage rate of CPU, a usage rate of a memory, disc access, a usage rate and vacant capacity of a file system, a usage rate and an error rate of a network interface etc. are detected.

Also, it is possible to recognize whether a designated process is operated on the system, whether or not the process is operated normally by the number of execution of the process. With regard to execution of an application, for exile, it is possible to monitor, by checking out a file renewal time and a file size, whether or not a file proper to an application is renewed.

Further, it is also possible to monitor monitoring of runaway of an application. This may recognize, for example, a case that CPU time that the application is consuming is excessive. Also, it is also possible to monitor a log of the application and occurrence of a bug. (3) According to need, the condition and abnormality relating to services which are provided by the server is monitored. For example, it is possible to also realize monitoring of transaction quantity, monitoring of interpolation of URL/data/file etc.

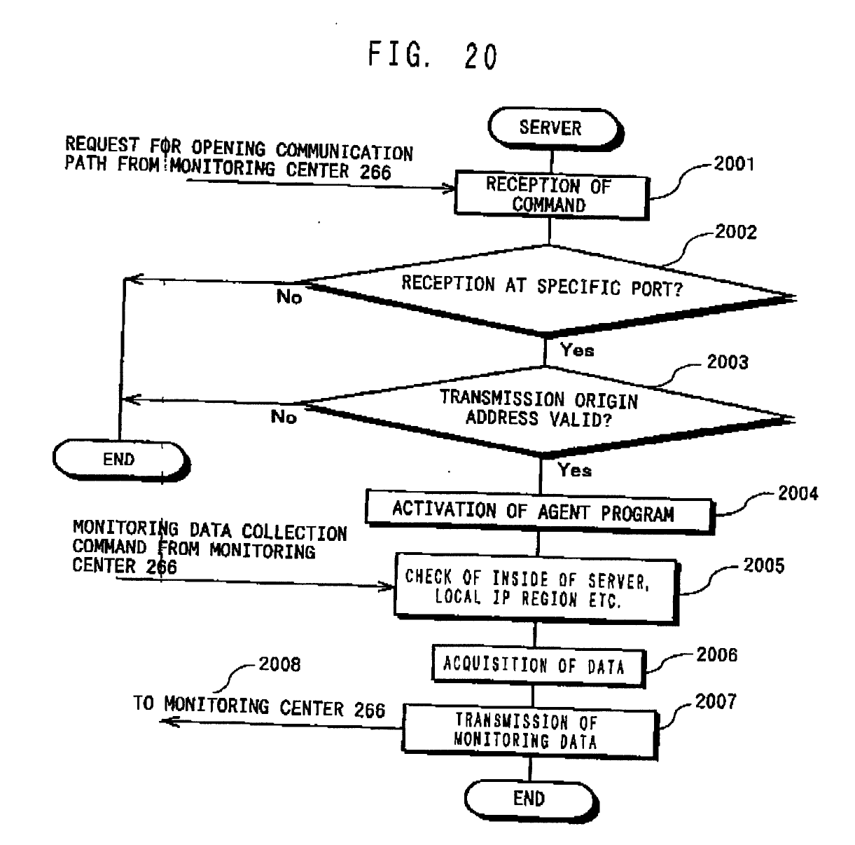

Even in the monitoring system 250 of such structure, registration of the operator and facility is carried out according to the processing shown in FIG. 14. In addition, by the above-described processing, information which identifies the server and information which identifies the service content are identified. By the latter, a classification of the agent program which will be described later is determined. Also, after the registration shown in FIG. 14, the operator, by operating the computer 228 and remotely logging in the server which himself/herself is operating (for example, reference numeral 282-l), can operate so as to download the agent program from the monitoring center 266 into the server 282. FIG. 19 is a view which shows one example of procedures of download of the agent program to the server which the operator is operating.

First, a communication path between the computer 228 of the operator side and the server 282 is opened (step 1901), and a user ID and a password are transmitted from the computer 228 to the server 282 (step 1902). The server 282 certifies a user (step 1903), and thereby, it becomes possible to remotely operate the server 282 by the computer 228 of the operator side. In addition, at the step 1903, in case that the customer certification fails, for example, because of inconsistency of the password, the processing is finished.

After that, the operator operates the computer 228, and thereby, the computer 228 designates the IP address etc. of the monitoring center 266 to the server 282 and instructs to download the agent program from the monitoring center 266 (step 1904).

When the communication path between the central system 274 of the monitoring center 266 and the server 282 is opened (step 1905), ad the transmission request of the agent program is transmitted to the central system 274 (step 1906 ), the central system 274, in response to this, sends a predetermined agent program to the server 282 (step 1907). Here, the central system 274, in reference to information (for example, IP address) which was transmitted and identifies a facility, identifies corresponding service content, and can select the agent program for realizing the service content.

When the server 282 receives the agent program, the agent program is stored in a storage device together with information (for example, IP address) which identifies the monitoring center 266 and information which shows a port assigned to the monitoring center 266.

Even in the monitoring system 250 configured like this, by procedures as shown in the step 1501 - step 1504 of FIG. 15, the monitoring data collection command is sent to the server which is the object to be monitored. The monitoring data collection command according to this embodiment is one which shows the activation of the agent program and sent to a port of a predetermined server.

FIGS. 20 is a flow chart which shows processing in the server 282. As shown in FIG. 20, when a communication path opening request is received from the monitoring center 266 (step 2001), the server 282 judges whether the command is one which was received by a specific port (step 2002), and further, whether an IP address of a transmission origin is valid (step 2003). In case that, at any step, it is judged to be No, processing by the server is finished.

In contrast to this, in case that it is judged to be Yes at both steps, the agent program 284 is activated (step 2004), and a communication path is opened with the monitoring center 266. When a monitoring center collection command from the monitoring center 266 is received, in response to this, the agent program 284 carries out the check of CPU at the server and the local IP address region (step 2005). When necessary data can be obtained (step 2006), this as the monitoring data is sent to the monitoring center 266 (step 2007). Data sent at this step 2007 (see reference numeral 2008) corresponds to the monitoring data which has been sent at the step 1506 of FIG. 15. Accordingly, since then, processing which is carried at the monitoring center 266 is the same as that shown in the steps 1507 - 1509 of FIG. 15 and FIG. 16.

After the notification is transmitted to the portable terminal 232 of the operator and the operator has ascertained this, it is possible to send various control commands to the monitoring center 266 and for the monitoring center 266 to carry out the processing responding to this, which is the same as that of the fourth embodiment.

As just described, according to the fifth embodiment, it. becomes possible to monitor in detail matters which can not be monitored from the global IP region, such as operating conditions of the CPU of the server and conditions of the local IP region, by downloading the agent program to the server and activating the agent program.

It is possible for this invention to change variously within the scope of the invention set forth in claims, without limitation of the foregoing embodiments, and it goes without saying that they are contained within the scope of the invention.

For example, in the first embodiment, the remote monitoring apparatus 20, through the global IP region, carries out monitoring of a server connected to this but it is not limited to this, and as to the monitoring from the side of the global IP region, the monitoring center 16 may carry it out. In short, the monitoring center 16 may bear a part of the monitoring, by carrying out the monitoring of the server through the global IP region.

Also, it goes without saying that the monitoring through the local IP region and the monitoring through the global IP region are not limited to ones recited in the above-described embodiments.

Further, in the fourth embodiment, it is possible for the monitoring center 216, according to the content registered from the operator, to monitor an arbitrary site and server such as a site, a predetermined server in the site etc.

Also, in the fifth embodiment, it is designed that the agent program is downloaded to a specific server (for example, see reference numeral 282-1), and the operating condition of the server and the condition of the local IP region which is connected can be monitored. However, it is not limited to this, and by the agent program, it is possible to monitor an entire site or a plurality of servers in the site. On the other hand, it may be configured that the agent program is downloaded with respect to each server, and the agent program is dedicated to monitor the conditions of the server which downloaded this and a neighboring local IP region.

Also, in the fifth embodiment, the remote log-in is utilized for downloading the agent program to the server 282 but it is not limited to this, and it goes without saying that the operator operates an input device of the server itself and may request the monitoring center 266 for transmission of the agent program.

Further, in the above-described fifth embodiment, it is configured that the agent program is activated by the command from the monitoring center. By this, it becomes possible to reduce a load at the side of the server. However, it is not limited to this, and it may be configured that a command which shows an activation timing is made to exist in the agent program itself, and the agent program is activated at a predetermined timing in the server.

Furthermore, it goes without saying that the monitoring which utilized the monitoring center and the monitoring which utilized the agent program are not limited to ones recited in the above-described fourth and fifth embodiments.

In addition, in the specification, a function of one means may be realized by two or more physical means, or, functions of two or more means may be realized by one physical means.

According to the invention, without assigning an operator to a site, and appropriately, it becomes possible to provide a monitoring system which can monitor a condition of a server in the site.

Also, according to the invention, by giving data to a server from both of a region (local IP region) of a dedicated network which is utilized for communication between sites and a global IP region which is utilized for communication with outside, it becomes possible to provide a monitoring system which can monitor its operating condition etc.

Also, according to the invention, without applying a load to a site operator, it becomes possible to provide a monitoring system which is capable of notifying an operating condition of the site to the site operator and controlling the site. Further, according to the invention, by disposing the monitoring center, it becomes possible to provide a monitoring system which can monitor a plurality of sites and servers in a unified manner.

1. (amended) a site monitoring apparatus which is disposed adjacently to a site having at least one server or more and monitor operating conditions of the site and/or the server, comprising, first communication processing means connected to a global IP region for communicating encrypted data with a central monitoring center through the global IP region at a first security level, second communication processing means connected to a local IP region for communicating data with the above-described server through the above-described local IP region at a second security level lower than the first security level, a monitoring execution means for generating predetermined data according to monitoring items for monitoring the operating conditions of the above-described site and/or server, and monitoring data generation means for receiving monitoring data which was returned from the above-described second communication processing means in response to data which was sent and relates to operating conditions of the above-described site and/or server and for generating data which shows the operating conditions according to the monitoring data, wherein the data which was generated by the above-described monitoring data generation means is notified to the above-described central monitoring center, through the above-described first processing means:

2. The site monitoring apparatus as set forth in claim 1, characterized in that the above-described second communication processing means is configured such that, in order to monitor, through the above-described global IP region, the operating conditions of the site and/or server connected to this, data which was given from the above-described monitoring execution means is sent out, and data which was returned through the above-described global IP region in response to the sending out of the data is accepted.

3. The site monitoring apparatus as set forth in claim 1 or 2 characterized in that, in case that the above-described monitoring execution means judges that there is something abnormal in th above-described site and/or server, based upon the above-described monitoring data, data which shows an alarm is generated, and data which is the data showing the alarm and was encrypted is transmitted from the first communication processing means to the central monitoring center at the first security level.

4. A central system of a central monitoring center for monitoring more than one site a cooperation with the site monitoring apparatus as set forth in any one of claims 1 through 31 characterized in that, it is configured that a control command which shows a manner of monitoring of the above-described site and/or server is applied to the above-described site monitoring apparatus at the first security level, and da from the above-described site monitoring apparatus is accepted, and according to the data, operating conditions of the site and/or server is grasped.

5. The central system as set forth in claim 4, configured such that, further, through the global IP region, a control command of other computer is accepted, and the control command is transmitted to a predetermined site monitoring apparatus.

6. The central system as set forth claim 4 or 5, characterized in that, further data from the above-described site monitoring apparatus is accepted, and a report based upon the data is prepared and transmitted to predetermined other computer.

7. The central system as set forth in any one of claim 4 through 6, characterized by further comprising a knowledge base and a supporting apparatus which indicates desired works to an operator in reference to the knowledge base.

8. (Amended) A method for monitoring a site having at least one server or more characterized by comprising, a step of sending data for monitoring the site and/or the server to the above-described server through a local IP region at a second security level, a, step of accepting monitoring data, in response to the above-described site and/or server, which shows the operating conditions of them, and a step of encrypting the above-described monitoring data and sending through a global IP region at a first security level higher than the second security level.

9. (Amended) The method as set forth in claim 8, characterized by further comprising a step of sending data for monitoring operating conditions, through the global IP region, of a site and/or a server connected to this.

10. In a site having at least one server or more, a central system connected:ted to the above-described site through a global IP region for monitoring operating conditions of the site and/or the server, comprising, communication processing means for transmitting a command to the above-described site and/or the server through the global IP region and accepting a response of the command, operating condition analysis means for analyzing operating conditions of the above-described site and/or the server according to the above-described accepted response, customer identification means for identifying a terminal device which was registered in advance in relation to the site and/or the server, in case that there occurs something wrong in the above-described site and/or the server based upon the analysis, and message preparation means for preparing a message for notifying the above-described something wrong, wherein it is configured that the prepared message is transmitted to the above-described terminal device through the global IP region.

11. The central system as set forth in claim 10, characterized in that the above-described customer identification means grasps information which shows the above-described site and/or, the server which were registered in advance and monitoring timing and monitoring content which were registered in relation to the information, and according to them, the command is transmitted to the above-described site and/or the server through the global IP region.

12. In a site having at least one or more server, a central system connected to the above-described site through a global IP region for monitoring operating conditions of the site and/or the server, comprising, agent program transfer means for transmitting to any server in the above-described site an agent program for monitoring operating conditions of at least inside of the above-described server and conditions of a local IP region connected to the above-described server, communication processing means for accepting data which was obtained in the above-described server by an operation of the above-described agent program, operating condition analysis means, according to the above-described accepted data, for analyzing operating conditions of the above-described site and/or the server, customer identification means for identifying a terminal device which was registered in advance in relation to the site and/or the server, in case that it was judged that there occurred something wrong in the above-described site and/or the server, based upon the analysis, and message preparation means for preparing a message for notifying the above-described something wrong, wherein it is configured that the prepared message is transmitted to the above-described terminal device through the global IP region.

13. The central system as set forth in claim 12, characterized in that the above-described communication processing means transfers to the above-described server an activation command which shows an activation of the agent program through the global IP region, and the above-described agent program is operated in response to the activation command.

14. In a site having at least one or more server, a site monitoring method for monitoring operating conditions of the site and/or the server, characterized by comprising, a step of transmitting a command to the above-described site and/or the server through a global IP region and of accepting a response of the command, a step of analyzing operating conditions of the above-described site and/or the server according to the above-described accepted response, a step of identifying a terminal device which was registered in advance in relation to the site and/or the server, in case that it was judged that there occurred something wrong in the above-described site and/or the server based upon the analysis, a step of preparing a message for notifying the above-described something wrong, and a step of transmitting the prepared message to the above-described terminal device through the global IP region.

15. The site monitoring method as set forth in claim 14, characterized in that, further, according to information showing the above-described site and/or the server which were registered in advance and monitoring timing and monitoring content which were registered in relation to the information, the command is transmitted to the above-described site and/or the server through the global IP region.

16. In a site having at least one server or more, a site monitoring method for monitoring operating conditions of the site and/or the server, characterized by comprising, a step of transmitting an agent program for monitoring at least operating conditions of inside of the above-described server and conditions of a local IP region connected to the above-described server to any server in the above-described site through a global. IP region and of urging the above-described server to store the agent program, a step of transmitting an activation command which shows an activation of the above-described agent program to the above-described server through the global IP region, a step of accepting data which was obtained by the above-described server due to operation of the above-described agent program, a step of analyzing operating conditions of the above-described site and/or the server according to the above-described received data, a step of identifying a terminal device which was registered in advance in relation to the site and/or the server, in case that it was judged that there occurs something wrong in the above-described site and/or the server according to the above-described analysis, a step of preparing a message for notifying the above-described something wrong, and a step of transmitting the prepared message to the above-described terminal device through the global IP region.

17. In a site having at least one server or more, a site monitoring method for monitoring operating conditions of the site and/or the server, characterized by comprising, a step of transmitting an agent program for monitoring, at a predetermined timing, at least operating conditions of inside of the above-described server and conditions of a local IP region connected to the above-described server to any server in the above-described site through a global IP region and of urging the above-described server to store the agent program, a step of accepting data which was obtained by the above-described server due to operation of the above-described agent program at the predetermined timing, a step of analyzing operating conditions of the above-described site and/or the server according to the above-described received data, a step of identifying a terminal device which was registered in advance in relation to the site and/or the server, in case that it was judged that there occurs something wrong in the above-described site and/or the server according to the above-described analysis, a step of preparing a message for notifying the above-described something wrong, and a step of transmitting the prepared message to the above-described terminal device through the global IP region.

18. The site monitoring method as set forth in claim 16 or 17, characterized in that, further, according to the monitoring content, a plurality of agent programs are prepared, and according to the invention which shows the above-described site and/or the server where were registered in advance and the monitoring content which was registered in relation to the information, the agent programmed to be transmitted to the above-described server is selected.

19. The site monitoring method as set forth in any one of claims 14 through 18, characterized in that the above described message
is transmitted as a mail to the terminal device.
